(19) United States
(12) Patent Application Publication
(10) Pub. No.: US 2011/0304656 A1
(43) Pub. Date: Dec. 15, 2011

(54) DISPLAY DEVICE AND ELECTRIC APPARATUS USING THE SAME

(75) Inventors: Shun Ueki, Osaka (JP); Toshiki Matsuoka, Osaka (JP); Kozo Nakamura, Osaka (JP); Takuma Tomotoshi, Osaka (JP)

(73) Assignee: SHARP KABUSHIKI KAISHA, Osaka-shi (JP)

(21) Appl. No.: 13/202,083

(22) PCT Filed: Sep. 24, 2009
(86) PCT No.: PCT/JP2009/066516

§ 371 Date: Aug. 17, 2011

(30) Foreign Application Priority Data
Feb. 20, 2009 (JP) 2009038262

(51) Int. Cl. G09G 5/10; G09G 5/00

(52) U.S. Cl. 345/690; 345/204; 345/211

(57) ABSTRACT

A display device (10) includes an upper substrate (first substrate) (2), a lower substrate (second substrate) (3), and a conductive liquid (16) that is sealed in a display space (S) formed between the upper substrate (2) and the lower substrate (3) so as to be moved toward an effective display region (P1) or a non-effective display region (P2). Ribs (14) are provided on the lower substrate (3) so as to partition the inside of the display space (S) in accordance with each of a plurality of pixel regions (P). The ribs (14) include first rib members (14a) formed in a perpendicular direction perpendicular to the direction of movement of the conductive liquid (16) and second rib members (14b) formed in a parallel direction parallel to the direction of movement of the conductive liquid (16). Clearances (K) are formed between each of the ends of the first and second rib members (14a, 14b).

### TECHNICAL FIELD

The present invention relates to a display device that displays information such as images and characters by moving a conductive liquid, and an electric apparatus using the display device.

### BACKGROUND ART

In recent years, as typified by an electrowetting type display device, a display device that displays information by utilizing a transfer phenomenon of a conductive liquid due to an external electric field has been developed and put to practical use.

Specifically, such a conventional display device includes first and second electrodes, first and second substrates, and a colored droplet that is sealed in a display space formed between the first substrate and the second substrate and serves as a conductive liquid that is colored a predetermined color (see, e.g., Patent Document 1). In this conventional display device, a voltage is applied to the colored droplet via the first electrode and the second electrode to change the shape of the colored droplet, thereby changing the display color on a display surface.

For the above conventional display device, another configuration also has been proposed, in which the first electrode and the second electrode are arranged side by side on the first substrate and electrically insulated from the colored droplet, and a third electrode is provided on the second substrate so as to face the first electrode and the second electrode. Moreover, a light-shielding shade is provided above the first electrode. Thus, the first electrode side and the second electrode side are defined as a non-effective display region and an effective display region, respectively. With this configuration, a voltage is applied so that a potential difference occurs between the first electrode and the third electrode or between the second electrode and the third electrode. In this case, compared to the way of changing the shape of the colored droplet, the colored droplet can be moved toward the first electrode or the second electrode at a high speed, and thus the display color on the display surface can be changed at a high speed as well.

### PRIOR ART DOCUMENTS

### Patent Documents

Patent Document 1; JP 2004-252444A

### DISCLOSURE OF INVENTION

### Problem to be Solved by the Invention

However, in the above conventional display device, pixel regions are completely separated from one another by cavity partitions (ribs), and the colored droplet (conductive liquid) is moved toward the first electrode (non-effective display region) or the second electrode (effective display region) in the internal space of each of the closed pixel regions. Therefore, it is difficult for the conventional display device to improve the speed of movement of the colored droplet.

With the foregoing in mind, it is an object of the present invention to provide a display device that can improve the speed of movement of a conductive liquid, and an electric apparatus using the display device.

### Means for Solving Problem

To achieve the above object, a display device of the present invention includes the following: a first substrate provided on a display surface side; a second substrate provided on a non-display surface side of the first substrate so that a predetermined display space is formed between the first substrate and the second substrate; an effective display region and a non-effective display region that are defined with respect to the display space; and a conductive liquid sealed in the display space so as to be moved toward the effective display region or the non-effective display region. The display device is capable of changing a display color on the display surface side by moving the conductive liquid. The display device includes the following a plurality of signal electrodes that are placed in the display space so as to come into contact with the conductive liquid, and are also provided along a predetermined arrangement direction; a plurality of reference electrodes that are provided on one of the first substrate and the second substrate so as to be electrically insulated from the conductive liquid and to be located on one of the effective display region side and the non-effective display region side, and are also arranged so as to intersect with the plurality of the signal electrodes; a plurality of scanning electrodes that are provided on one of the first substrate and the second substrate so as to be electrically insulated from the conductive liquid and the plurality of the reference electrodes and to be located on the other of the effective display region side and the non-effective display region side, and are also arranged so as to intersect with the plurality of the signal electrodes; a plurality of pixel regions that are located at each of the intersections of the plurality of the signal electrodes and the plurality of the scanning electrodes; and ribs that are provided on one of the first substrate and the second substrate so as to partition the inside of the display space in accordance with each of the plurality of the pixels regions. The ribs are provided with clearances through which the adjacent pixel regions can communicate with each other.

In the display device having the above configuration, the ribs are provided on one of the first substrate and the second substrate so as to partition the inside of the display space in accordance with each of the plurality of the pixel regions. Moreover, the ribs are provided with the clearances through which the adjacent pixel regions can communicate with each other. Thus, unlike the conventional example, since the clearances are formed between the adjacent pixel regions, the conductive liquid can be moved smoothly, so that the speed of movement of the conductive liquid can be improved.

In the above display device, the ribs may include first rib members formed in a perpendicular direction perpendicular to a direction of movement of the conductive liquid and second rib members formed in a parallel direction parallel to the direction of movement of the conductive liquid, and at least one of the first rib members and the second rib members may be provided with the clearances.

In this case, due to the presence of the clearances provided with respect to at least one of the first rib members and the second rib members, the conductive liquid can be moved smoothly, and thus the speed of movement of the conductive liquid can be improved.

In the above display device, each of the first rib members may be divided into a plurality of first rib members in the perpendicular direction, and at least one of the clearances may be formed between the divided first rib members.

In this case, at least one of the clearances is formed between the first rib members that are separated in the perpendicular direction. Due to the presence of the at least one of the clearances, the conductive liquid can be moved smoothly, and thus the speed of movement of the conductive liquid can be improved.

In the above display device, each of the second rib members may be divided into a plurality of second rib members in the parallel direction, and at least one of the clearances may be formed between the divided second rib members.

In this case, at least one of the clearances is formed between the second rib members that are separated in the parallel direction. Due to the presence of the at least one of the clearances, the conductive liquid can be moved smoothly, and thus the speed of movement of the conductive liquid can be improved.

In the above display device, it is preferable that each of the second rib members is divided into a plurality of second rib members in the parallel direction so that the clearances are formed at least between the effective display region and the non-effective display region.

In this case, when the conductive liquid is moved toward the effective display region or the non-effective display region, at least one of the clearances is present in the vicinity of the starting point of the movement of the conductive liquid 16. Therefore, the conductive liquid 16 can be moved more smoothly, and the speed of movement of the conductive liquid 16 can be improved reliably.

In the above display device, the ribs may include first rib members formed in a perpendicular direction perpendicular to a direction of movement of the conductive liquid and second rib members formed in a parallel direction parallel to the direction of movement of the conductive liquid, and the clearances may be formed between each of the ends of the first rib members and the second rib members.

In this case, the clearances are provided in four corners of each of the pixel regions, and due to the presence of these clearances, the conductive liquid can be moved smoothly, and thus the speed of movement of the conductive liquid can be improved.

In the above display device, the ribs may be provided on one of the first substrate and the second substrate so that the clearances are formed between the ribs and the other of the first substrate and the second substrate.

In this case, due to the presence of the clearances formed between the ribs and the other of the first substrate and the second substrate, the conductive liquid can be moved smoothly, and thus the speed of movement of the conductive liquid can be improved.

In the above display device, it is preferable that the display device includes the following: a signal voltage application portion that is connected to the plurality of the signal electrodes and applies a signal voltage in a predetermined voltage range to each of the signal electrodes in accordance with information to be displayed on the display surface side; a reference voltage application portion that is connected to the plurality of the reference electrodes and applies one of a selected voltage and a non-selected voltage to each of the reference electrodes, the selected voltage allowing the conductive liquid to move in the display space in accordance with the signal voltage and the non-selected voltage inhibiting a movement of the conductive liquid in the display space; and a scanning voltage application portion that is connected to the plurality of the scanning electrodes and applies one of a selected voltage and a non-selected voltage to each of the scanning electrodes, the selected voltage allowing the conductive liquid to move in the display space in accordance with the signal voltage the non-selected voltage inhibiting a movement of the conductive liquid in the display space.

In this case, a matrix-driven display device with excellent display quality can be easily provided, and the display color in each of the pixel regions can be appropriately changed.

In the above display device, the plurality of the pixel regions may be provided in accordance with a plurality of colors that enable full-color display to be shown on the display surface side.

In this case, the color image display can be performed by moving the corresponding conductive liquid properly in each of the pixels.

In the above display device, it is preferable that an insulating fluid that is not mixed with the conductive liquid is movably sealed in the display space.

In this case, the speed of movement of the conductive liquid can be easily improved.

In the above display device, it is preferable that a dielectric layer is formed on the surfaces of the plurality of the reference electrodes and the plurality of the scanning electrodes.

In this case, the dielectric layer reliably increases the electric field applied to the conductive liquid, so that the speed of movement of the conductive liquid can be more easily improved.

In the above display device, the non-effective display region may be defined by a light-shielding layer that is provided on one of the first substrate and the second substrate, and the effective display region may be defined by an aperture formed in the light-shielding layer.

In this case, the effective display region and the non-effective display region can be properly and reliably defined with respect to the display space.

An electric apparatus of the present invention includes a display portion that displays information including characters and images. The display portion includes any of the above display devices.

In the electric apparatus having the above configuration, the display portion uses the display device that can improve the speed of movement of the conductive liquid. Thus, a high-performance electric apparatus capable of changing the display color in each of the pixel regions at a high speed can be easily provided.

### Effects of the Invention

The present invention can provide a display device that can improve the speed of movement of the conductive liquid, and an electric apparatus using the display device.

### BRIEF DESCRIPTION OF DRAWINGS

FIG. 1 is plan view for explaining a display device and an image display apparatus of Embodiment 1 of the present invention.

FIG. 2 is an enlarged plan view showing the main configuration of the upper substrate in FIG. 1 when viewed from a display surface side.

FIG. 3 is an enlarged plan view showing the main configuration of the lower substrate in FIG. 1 when viewed from a non-display surface side.

FIGS. 4A and 4B are cross-sectional views showing the main configuration of the display device in FIG. 1 during non-CF color display and CF color display, respectively.

FIG. 5 is a diagram for explaining an operation example of the image display apparatus.

FIG. 6 is an enlarged plan view showing the main configuration of a lower substrate in a display device of Embodiment 2 of the present invention when viewed from a non-display surface side.

FIG. 7 is an enlarged plan view showing the main configuration of a lower substrate in a display device of Embodiment 3 of the present invention when viewed from a non-display surface side.

FIG. 8 is an enlarged plan view showing the main configuration of a lower substrate in a display device of Embodiment 4 of the present invention when viewed from a non-display surface side.

FIGS. 9A and 9B are cross-sectional views showing the main configuration of a display device of Embodiment 5 of the present invention during non-CF color display and CF color display, respectively.

### DESCRIPTION OF THE INVENTION

Hereinafter, preferred embodiments of a display device and an electric apparatus of the present invention will be described with reference to the drawings. In the following description, the present invention is applied to an image display apparatus including a display portion that can display color images. The size and size ratio of each of the constituent members in the drawings do not exactly reflect those of the actual constituent members.

### Embodiment 1

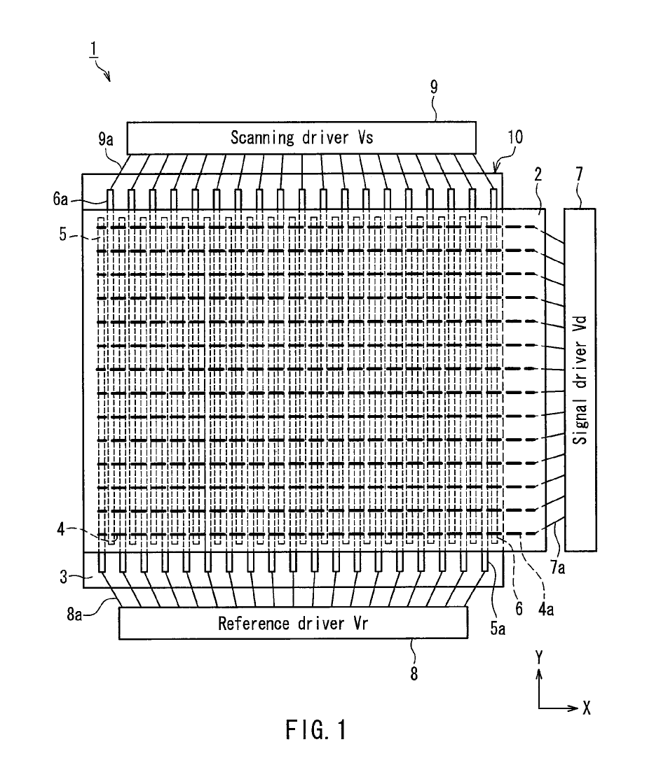

FIG. 1 is a plan view for explaining a display device and an image display apparatus of Embodiment 1 of the present invention. In FIG. 1, an image display apparatus 1 of this embodiment includes a display portion using a display device 10 of the present invention. The display portion has a rectangular display surface. The display device 10 includes an upper substrate 2 and a lower substrate 3 that are arranged to overlap each other in a direction perpendicular to the sheet of FIG. 1. The overlap between the upper substrate 2 and the lower substrate 3 forms an effective display region of the display surface (as will be described in detail later).

In the display device 10, a plurality of signal electrodes 4 are spaced at predetermined intervals and arranged in stripes in the X direction. Moreover, in the display device 10, a plurality of reference electrodes 5 and a plurality of scanning electrodes 6 are alternately arranged in stripes in the Y direction. The plurality of the signal electrodes 4 intersect with the plurality of the reference electrodes 5 and the plurality of the scanning electrodes 6, and a plurality of pixel regions are located at each of the intersections of the signal electrodes 4 and the scanning electrodes 6.

The signal electrodes 4, the reference electrodes 5, and the scanning electrodes 6 are configured so that voltages can be independently applied to these electrodes, and the voltages fall in a predetermined voltage range between a High voltage (referred to as “H voltage” in the following) that serves as a first voltage and a Low voltage (referred to as “L voltage” in the following) that serves as a second voltage (as will be described in detail later).

In the display device 10, the pixel regions are separated from one another by ribs and provided in accordance with a plurality of colors that enable full-color display to be shown on the display surface, as will be described in detail later. The display device 10 changes the display color on the display surface by moving a conductive liquid (as will be described later) for each of a plurality of pixels (display cells) arranged in a matrix using an electrowetting phenomenon.

One end of the signal electrodes 4, the reference electrodes 5, and the scanning electrodes 6 are extended to the outside of the effective display region of the display surface and form terminals 4a, 5a, and 6a, respectively.

A signal driver 7 is connected to the individual terminals 4a of the signal electrodes 4 via wires 7a. The signal driver 7 constitutes a signal voltage application portion and applies a signal voltage Vd to each of the signal electrodes 4 in accordance with information when the image display apparatus 1 displays the information including characters and images on the display surface.

A reference driver 8 is connected to the individual terminals 5a of the reference electrodes 5 via wires 8a. The reference driver 8 constitutes a reference voltage application portion and applies a reference voltage Vr to each of the reference electrodes 5 when the image display apparatus 1 displays the information including characters and images on the display surface.

A scanning driver 9 is connected to the individual terminals 6a of the scanning electrodes 6 via wires 9a. The scanning driver 9 constitutes a scanning voltage application portion and applies a scanning voltage Vs to each of the scanning electrodes 6 when the image display apparatus 1 displays the information including characters and images on the display surface.

The scanning driver 9 applies either a non-selected voltage or a selected voltage to each of the scanning electrodes 6 as the scanning voltage Vs. The non-selected voltage inhibits the movement of the conductive liquid and the selected voltage allows the conductive liquid to move in accordance with the signal voltage Vd. Moreover, the reference driver 8 is operated with reference to the operation of the scanning driver 9. The reference driver 8 applies either the non-selected voltage that inhibits the movement of the conductive liquid or the selected voltage that allows the conductive liquid to move in accordance with the signal voltage Vd to each of the reference electrodes 5 as the reference voltage Vr.

In the image display apparatus 1, the scanning driver 9 applies the selected voltage to each of the scanning electrodes 6 in sequence, e.g., from the left to the right of FIG. 1, and the reference driver 8 applies the selected voltage to each of the scanning electrodes 6 in sequence from the left to the right of FIG. 1 in synchronization with the operation of the scanning driver 9. Thus, the scanning driver 9 and the reference driver 8 perform their respective scanning operations for each line (as will be described in detail later).

The signal driver 7, the reference driver 8, and the scanning driver 9 include a direct-current power supply or an alternating-current power supply that supplies the signal voltage Vd, the reference voltage Vr, and the scanning voltage Vs, respectively.

The reference driver 8 switches the polarity of the reference voltage Vr at predetermined time intervals (e.g., 1 frame). Moreover, the scanning driver 9 switches the polarity of the scanning voltage Vs in accordance with the switching of the polarity of the reference voltage Vr. Thus, since the polarities of the reference voltage Vr and the scanning voltage Vs are switched at predetermined time intervals, the localization of charges in the reference electrodes 5 and the scanning electrodes 6 can be prevented, compared to the case where the voltages with the same polarity are always applied to the reference electrodes 5 and the scanning electrodes 6. Moreover, it is possible to prevent the adverse effects of a display failure (after-image phenomenon) and low reliability (a reduction in life) due to the localization of charges.

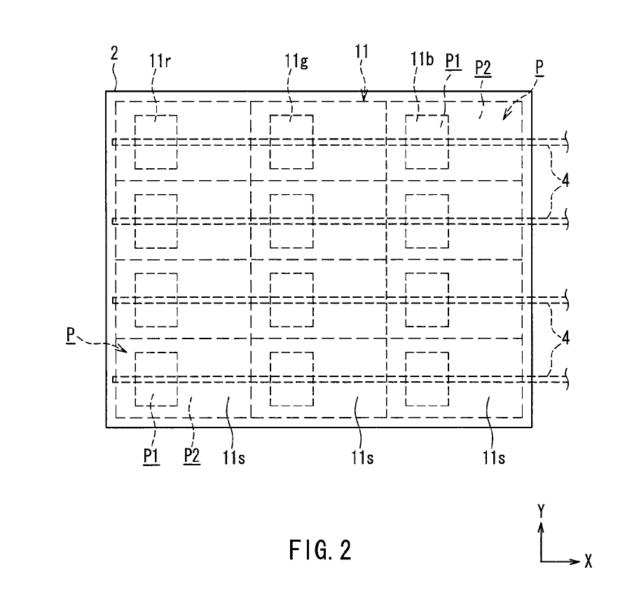

The pixel structure of the display device 10 will be described in detail with reference to FIGS. 2 to 4 as well as FIG. 1.

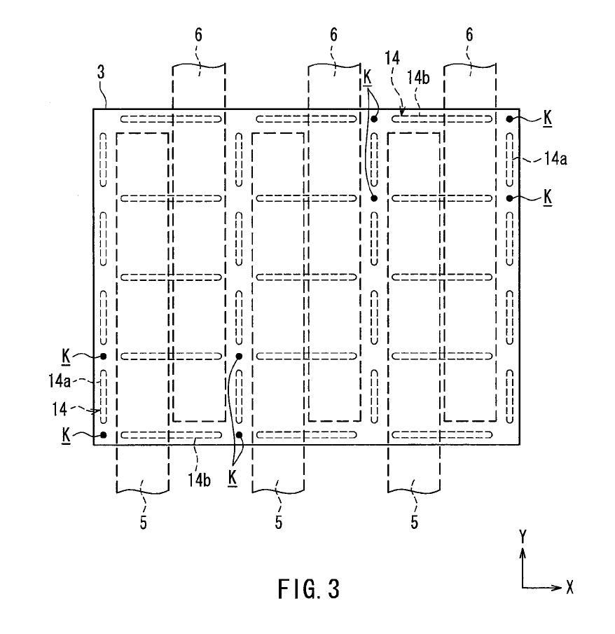

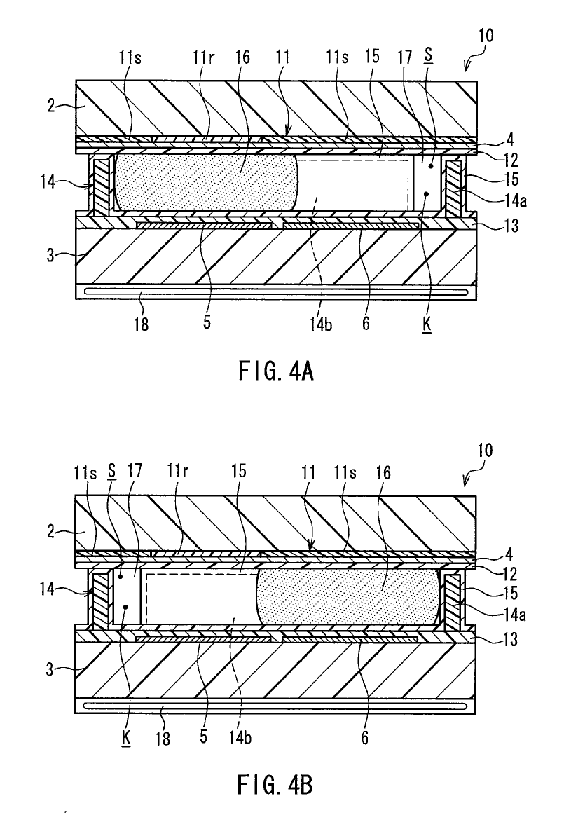

FIG. 2 is an enlarged plan view showing the main configuration of the upper substrate in FIG. 1 when viewed from the display surface side. FIG. 3 is an enlarged plan view showing the main configuration of the lower substrate in FIG. 1 when viewed from the non-display surface side. FIGS. 4A and 4B are cross-sectional views showing the main configuration of the display device in FIG. 1 during non-CF color display and CF color display, respectively. For the sake of simplification, FIGS. 2 and 3 show twelve pixels placed at the upper left corner of the plurality of pixels on the display surface in FIG. 1.

In FIGS. 2 to 4, the display device 10 includes the upper substrate 2 that is provided on the display surface side and serves as a first substrate, and the lower substrate 3 that is provided on the back (i.e., the non-display surface side) of the upper substrate 2 and serves as a second substrate. In the display device 10, the upper substrate 2 and the lower substrate 3 are located at a predetermined distance away from each other, so that a predetermined display space S is formed between the upper substrate 2 and the lower substrate 3. The conductive liquid 16 and an insulating oil 17 that is not mixed with the conductive liquid 16 are sealed in the display space S and can be moved in the X direction (the lateral direction of FIG. 4). The conductive liquid 16 can be moved toward an effective display region P1 or a non-effective display region P2, as will be described later.

The conductive liquid 16 can be, e.g., an aqueous solution including water as a solvent and a predetermined electrolyte as a solute. Specifically, 1 mmol/L of potassium chloride (KCD aqueous solution may be used as the conductive liquid 16. Moreover, the conductive liquid 16 is colored black, e.g., with a self-dispersible pigment.

The conductive liquid 16 is colored black and therefore functions as a shutter that allows or prevents light transmission. When the conductive liquid 16 is slidably moved in the display space S toward the reference electrode 5 (i.e., the effective display region P1) or the scanning electrode 6 (i.e., the non-effective display region P2), the display color of each pixel of the display device 10 is changed to black or any color of RBG, as will be described in detail later.

The oil 17 can be, e.g., a nonpolar, colorless, and transparent oil including one or more than one selected from a side-chain higher alcohol, a side-chain higher fatty acid, an alkane hydrocarbon, a silicone oil, and a matching oil. The oil 17 is shifted in the display space S as the conductive liquid 16 is slidably moved.

The upper substrate 2 can be, e.g., a transparent glass material such as a non-alkali glass substrate or a transparent sheet material such as a transparent synthetic resin (e.g., an acrylic resin). A color filter layer 11 and the signal electrodes 4 are formed in this order on the surface of the upper substrate 2 that faces the non-display surface side. Moreover, a hydrophobic film 12 is formed to cover the color filter layer 11 and the signal electrodes 4.

Like the upper substrate 2, the lower substrate 3 can be, e.g., a transparent glass material such as a non-alkali glass substrate or a transparent sheet material such as a transparent synthetic resin (e.g., an acrylic resin). The reference electrodes 5 and the scanning electrodes 6 are provided on the surface of the lower substrate 3 that faces the display surface side. Moreover, a dielectric layer 13 is formed to cover the reference electrodes 5 and the scanning electrodes 6. First rib members 14a and second rib members 14b are formed parallel to the Y direction and the X direction, respectively, on the surface of the dielectric layer 13 that faces the display surface side. In the lower substrate 3, a hydrophobic film 15 is further formed to cover the dielectric layer 13 and the first and second rib members 14a, 14b.

A backlight 18 that emits, e.g., white illumination light is integrally attached to the back (i.e., the non-display surface side) of the lower substrate 3, thus providing a transmission type display device 10. The backlight 18 uses a light source such as a cold cathode fluorescent tube or a LED.

The color filter layer 11 includes red (R), green (G), and blue (B) color filters 11r, 11g, and 11b and a black matrix 11s serving as a light-shielding layer, thereby constituting the pixels of R, G, and B colors. In the color filter layer 11, as shown in FIG. 2, the R, G, and B color filters 11r, 11g, and 11b are successively arranged in columns in the X direction, and each column includes four color filters in the Y direction. Thus, a total of twelve pixels are arranged in three columns (the X direction) and four rows (the Y direction).

As shown in FIG. 2, in each of the pixel regions P of the display device 10, any of the R, G, and B color filters 11r, 11g, and 11b is provided in a portion corresponding to the effective display region P1 and the black matrix 11s is provided in a portion corresponding to the non-effective display region P2 of the pixel. In other words, with respect to the display space S, the non-effective display region (non-aperture region) P2 is defined by the black matrix (light-shielding layer) 11s and the effective display region P1 is defined by an aperture (i.e., any of the color filters 11r, 11g, and 11b) formed in that black matrix 11s.

In the display device 10, the area of each of the color filters 11r, 11g, and 11b is the same as or slightly larger than that of the effective display region P1. On the other hand, the area of the black matrix 11s is the same as or slightly smaller than that of the non-effective display region P2. In FIG. 2, the boundary between two black matrixes 11s corresponding to the adjacent pixels is indicated by a dotted line to clarify the boundary between the adjacent pixels. Actually, however, no boundary is present between the black matrixes 11s of the color filter layer 11.

In the display device 10, the inside of the display space S is divided into the pixel regions P by the ribs 14 that serve as partitions and have the first rib members 14a and the second rib members 14b. As shown in FIG. 3, in the display device 10, the inside of the display space S of each pixel is partitioned by the ribs 14 that surround the corresponding pixel region P. Specifically, the inside of the display space S of each pixel is partitioned by two first rib members 14a formed parallel to the Y direction (i.e., a perpendicular direction perpendicular to the direction of movement of the conductive liquid 16) and two first rib members 14b formed parallel to the X direction (i.e., a parallel direction parallel to the direction of movement of the conductive liquid 16).

The first and second rib members 14a, 14b of the ribs 14 are made of, e.g., an epoxy resin resist material. In the ribs 14, the first and second rib members 14a, 14b are formed on the dielectric layer 13 provided on the lower substrate 3 so that no gap is created between the upper substrate 2 and the first and second rib members 14a, 14b. Specifically, as shown in FIG. 4, the first and second rib members 14a, 14b are formed on the dielectric layer 13 provided on the lower substrate 3 so that the hydrophobic film 15 covering the first and second rib members 14a, 14b is in contact with the hydrophobic film 12 provided on the upper substrate 2.

Moreover, clearances K through which the adjacent pixel regions P can communicate with each other are formed between each of the ends of the first and second rib members 14a, 14b of the ribs 14, as shown in FIG. 3. That is, each of the pixel regions P has four clearances K in the four corners.

When a distance between the inner surfaces of the two opposing first rib members 14a is defined as a lateral size of the pixel region P in the X direction, the size of each of the second rib members 14b in the X direction is set in the range of 66% to 96% of the lateral size. These second rib members 14b are bilaterally symmetrical with respect to the center in the X direction. Therefore, the size of each of the two clearances K at both ends of the second rib member 14b in the X direction is set to one-half of the size obtained by subtracting the size of the second rib member 14b in the X direction from the lateral size, i.e., in the range of 2% to 17% of the lateral size.

When a distance between the inner surfaces of the two opposing second rib members 14b is defined as a vertical size of the pixel region P in the Y direction, the size of each of the first rib members 14a in the Y direction is set in the range of 34% to 96% of the vertical size. These first rib members 14a are bilaterally symmetrical with respect to the center in the Y direction. Therefore, the size of each of the two clearances K at both ends of the first rib member 14a in the Y direction is set to one-half of the size obtained by subtracting the size of the first rib member 14a in the Y direction from the vertical size, i.e., in the range of 2% to 33% of the vertical size.

The hydrophobic films 12, 15 are made of, e.g., a transparent synthetic resin, and preferably a fluoro polymer that functions as a hydrophilic layer for the conductive liquid 16 when a voltage is applied. This can significantly change the wettability (contact angle) between the conductive liquid 16 and each of the surfaces of the upper and lower substrates 2, 3 that face the display space S. Thus, the speed of movement of the conductive liquid 16 can be improved. The dielectric layer 13 can be, e.g., a transparent dielectric film containing parylene, a silicon nitride, a hafnium oxide, a zinc oxide, a titanium dioxide, or an aluminum oxide. A specific thickness of each of the hydrophobic films 12, 15 ranges from several hundred nanometers to several micrometers. A specific thickness of the dielectric layer 13 is several hundred nanometers. The hydrophobic film 12 does not electrically insulate the signal electrodes 4 from the conductive liquid 16, and therefore not interfere with the improvement in responsibility of the conductive liquid 16.

The reference electrodes 5 and the scanning electrodes 6 are made of, e.g., transparent electrode materials such as indium oxides (ITO), tin oxides (SnO₂), and zinc oxides (AZO, GZO, or IZO). The reference electrodes 5 and the scanning electrodes 6 are formed in stripes on the lower substrate 3 by a known film forming method such as sputtering.

The signal electrodes 4 can be, e.g., linear wiring that is arranged parallel to the X direction. The signal electrodes 4 are placed on the color filter layer 11 so as to extend substantially through the center of each of the pixel regions P in the Y direction, and further to come into electrical contact with the conductive liquid 16 via the hydrophobic film 12. This can improve the responsibility of the conductive liquid 16 during a display operation.

A material that is electrochemically inert to the conductive liquid 16 is used for the signal electrodes 4. Therefore, even if the signal voltage Vd (e.g., 40 V) is applied to the signal electrodes 4, the electrochemical reaction between the signal electrodes 4 and the conductive liquid 16 can be minimized. Thus, it is possible to prevent electrolysis of the signal electrodes 4 and to improve the reliability and life of the display device 10.

Specifically, the signal electrodes 4 are made of, e.g., an electrode material including at least one of gold, silver, copper, platinum, and palladium. The signal electrodes 4 may be formed by fixing thin wires made of the above metal material on the color filter layer 11 or by mounting an ink material such as a conductive paste containing the metal material on the color filter layer 11 with screen printing or the like.

The shape of the signal electrode 4 is determined using the transmittance of the reference electrode 5 located below the effective display region P1 of the pixel. Specifically, based on a transmittance of about 75% to 95% of the reference electrode 5, the shape of the signal electrode 4 is determined so that the occupation area of the signal electrode 4 on the effective display region P1 is 30% or less, preferably 10% or less, and more preferably 5% or less of the area of the effective display region P1.

In each pixel of the display device 10 having the above configuration, as shown in FIG. 4A, when the conductive liquid 16 is held between the color filter 11r and the reference electrode 5, light from the backlight 18 is blocked by the conductive liquid 16, so that the black display (non-CF color display) is performed. On the other hand, as shown in FIG. 4B, when the conductive liquid 16 is held between the black matrix 11s and the scanning electrode 6, light from the backlight 18 is not blocked by the conductive liquid 16 and passes through the color filter 11r, so that the red display (CF color display) is performed.

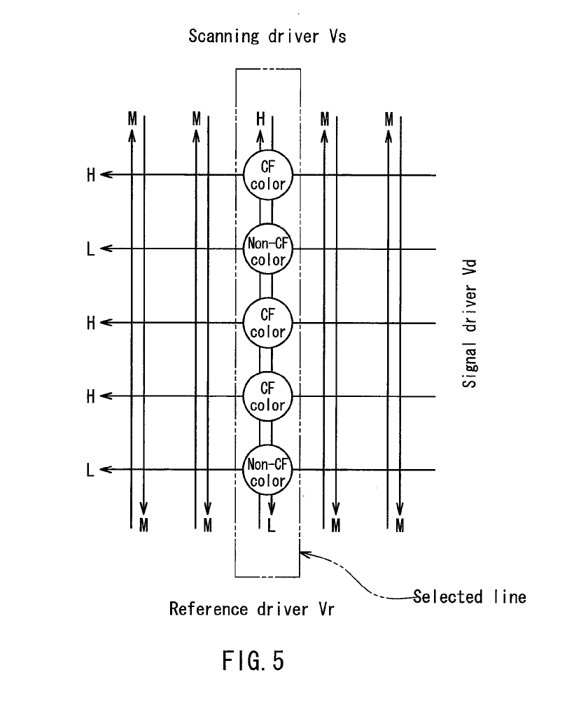

Hereinafter, a display operation of the image display apparatus 1 of this embodiment having the above configuration will be described in detail with reference to FIG. 5 as well as FIGS. 1 to 4.

FIG. 5 is a diagram for explaining an operation example of the image display apparatus 1.

In FIG. 5, the reference driver 8 and the scanning driver 9 apply the selected voltages (i.e., the reference voltage Vr and the scanning voltage Vs) to the reference electrodes 5 and the scanning electrodes 6 in sequence in a predetermined scanning direction, e.g., from the left to the right of FIG. 5, respectively. Specifically, the reference driver 8 and the scanning driver 9 perform their scanning operations to determine a selected line by applying the H voltage (first voltage) and the L voltage (second voltage) as the selected voltages to the reference electrodes 5 and the scanning electrodes 6 in sequence, respectively. In this selected line, the signal driver 7 applies the H or L voltage (i.e., the signal voltage Vd) to the corresponding signal electrodes 4 in accordance with the external image input signal. Thus, in each of the pixels of the selected line, the conductive liquid 16 is moved toward the effective display region P1 or the non-effective display region P2, and the display color on the display surface is changed accordingly.

On the other hand, the reference driver 8 and the scanning driver 9 apply the non-selected voltages (i.e., the reference voltage Vr and the scanning voltage Vs) to non-selected lines, namely to all the remaining reference electrodes 5 and scanning electrodes 6, respectively. Specifically, the reference driver 8 and the scanning driver 9 apply, e.g., intermediate voltages (Middle voltages, referred to as “M voltages” in the following) between the H voltage and the L voltage as the non-selected voltages to all the remaining reference electrodes 5 and scanning electrodes 6, respectively. Thus, in each of the pixels of the non-selected lines, the conductive liquid 16 stands still without unnecessary displacement from the effective display region P1 or the non-effective display region P2, and the display color on the display surface is unchanged.

Table 1 shows the combinations of the voltages applied to the reference electrodes 5, the scanning electrodes 6, and the signal electrodes 4 in the above display operation. As shown in Table 1, the behavior of the conductive liquid 16 and the display color on the display surface depend on the applied voltages. In Table 1, the H voltage, the L voltage, and the M voltage are abbreviated to “H”, “L”, and “M”, respectively (the same is true for Table 2 in the following). The specific values of the H voltage, the L voltage, and the M voltage are, e.g., +16 V, 0 V, and +8 V, respectively.

TABLE 1

| | | | | Behavior of conductive |
|---|---|---|---|---|
| | Reference | Scanning | Signal | liquid and display color |
| | electrode | electrode | electrode | on display surface |
| Selected | H | L | H | The conductive liquid is |
| line | | | | moved toward the scanning |
| | | | | electrode. |
| | | | | CF color display |
| | | | L | The conductive liquid is |
| | | | | moved toward the reference |
| | | | | electrode. |
| | | | | Black display |
| Non- | M | M | H | The conductive liquid is |
| selected | | | | still (not moving). |
| line | | | L | Black or CF color display |

### <Selected Line Operation>

In the selected line, e.g., when the H voltage is applied to the signal electrodes 4, there is no potential difference between the reference electrode 5 and the signal electrodes 4 because the H voltage is applied to both of these electrodes. On the other hand, a potential difference between the signal electrodes 4 and the scanning electrode 6 occurs because the L voltage is applied to the scanning electrode 6. Therefore, the conductive liquid 16 is moved in the display space S toward the scanning electrode 6 that makes a potential difference from the signal electrodes 4. Consequently, the conductive liquid 16 has been moved toward the non-effective display region P2, as shown in FIG. 4B, and allows the illumination light emitted from the backlight 18 to reach the color filter 11r by shifting the oil 17 toward the reference electrode 5. Thus, the display color on the display surface becomes red display (i.e., the CF color display) due to the color filter 11r. In the image display apparatus 1, when the CF color display is performed in all the three adjacent R, G, and B pixels as a result of the movement of the conductive liquid 16 toward the non-effective display region P2, the red, green, and blue colors of light from the corresponding R, G, and B pixels are mixed into white light, resulting in the white display.

In the selected line, when the L voltage is applied to the signal electrodes 4, a potential difference occurs between the reference electrode 5 and the signal electrodes 4, but not between the signal electrodes 4 and the scanning electrode 6. Therefore, the conductive liquid 16 is moved in the display space S toward the reference electrode 5 that makes a potential difference from the signal electrodes 4. Consequently, the conductive liquid 16 has been moved toward the effective display region P1, as shown in FIG. 4A, and prevents the illumination light emitted from the backlight 18 from reaching the color filter 11r. Thus, the display color on the display surface becomes black display (i.e., the non-CF color display) due to the presence of the conductive liquid 16.

### <Non-Selected Line Operation>

In the non-selected lines, e.g., when the H voltage is applied to the signal electrodes 4, the conductive liquid 16 stands still in the same position, and the current display color is maintained. Since the M voltages are applied to both the reference electrodes 5 and the scanning electrodes 6, the potential difference between the reference electrodes 5 and the signal electrodes 4 is the same as that between the scanning electrodes 6 and the signal electrodes 4. Consequently, the display color is maintained without changing from the black display or the CF color display in the current state.

Similarly, in the non-selected lines, even when the L voltage is applied to the signal electrodes 4, the conductive liquid 16 stands still in the same position, and the current display color is maintained. Since the M voltages are applied to both the reference electrodes 5 and the scanning electrodes 6, the potential difference between the reference electrodes 5 and the signal electrodes 4 is the same as that between the scanning electrodes 6 and the signal electrodes 4.

As described above, in the non-selected lines, the conductive liquid 16 is not moved, but stands still and the display color on the display surface is unchanged regardless of whether the H or L voltage is applied to the signal electrodes 4.

On the other hand, in the selected line, the conductive liquid 16 can be moved in accordance with the voltage applied to the signal electrodes 4, as described above, and the display color on the display surface can be changed accordingly.

In the image display apparatus 1, depending on the combinations of the applied voltages in Table 1, the display color of each pixel on the selected line can be, e.g., the CF colors (red, green, or blue) produced by the color filters 11r, 11g, and 11b or the non-CF color (black) due to the conductive liquid 16 in accordance with the voltage applied to the signal electrodes 4 corresponding to the individual pixels, as shown in FIG. 5. When the reference driver 8 and the scanning driver 9 determine a selected line of the reference electrode 5 and the scanning electrode 6 by performing their scanning operations, e.g., from the left to the right of FIG. 5, the display colors of the pixels in the display portion of the image display apparatus 1 also are changed in sequence from the left to the right of FIG. 5. Therefore, if the reference driver 8 and the scanning driver 9 perform the scanning operations at a high speed, the display colors of the pixels in the display portion of the image display apparatus 1 also can be changed at a high speed. Moreover, by applying the signal voltage Vd to the signal electrodes 4 in synchronization with the scanning operation for the selected line, the image display apparatus 1 can display various information including dynamic images based on the external image input signal.

The combinations of the voltages applied to the reference electrodes 5, the scanning electrodes 6, and the signal electrodes 4 are not limited to Table 1, and may be as shown in Table 2.

TABLE 2

| | | | | Behavior of conductive |
|---|---|---|---|---|
| | Reference | Scanning | Signal | liquid and display color |
| | electrode | electrode | electrode | on display surface |
| Selected | L | H | L | The conductive liquid is |
| line | | | | moved toward the scanning |
| | | | | electrode. |
| | | | | CF color display |
| | | | H | The conductive liquid is |
| | | | | moved toward the reference |
| | | | | electrode. |
| | | | | Black display |
| Non- | M | M | H | The conductive liquid is |
| selected | | | | still (not moving). |
| line | | | L | Black or CF color display |

The reference driver 8 and the scanning driver 9 perform their scanning operations to determine a selected line by applying the L voltage (second voltage) and the H voltage (first voltage) as the selected voltages to the reference electrodes 5 and the scanning electrodes 6 in sequence in a predetermined scanning direction, e.g., from the left to the right of FIG. 5, respectively. In this selected line, the signal driver 7 applies the H or L voltage (i.e., the signal voltage Vd) to the corresponding signal electrodes 4 in accordance with the external image input signal.

On the other hand, the reference driver 8 and the scanning driver 9 apply the M voltages as the non-selected voltages to the non-selected lines, namely to all the remaining reference electrodes 5 and scanning electrodes 6.

### <Selected Line Operation>

In the selected line, e.g., when the L voltage is applied to the signal electrodes 4, there is no potential difference between the reference electrode 5 and the signal electrodes 4 because the L voltage is applied to both of these electrodes. On the other hand, a potential difference between the signal electrodes 4 and the scanning electrode 6 occurs because the H voltage is applied to the scanning electrode 6. Therefore, the conductive liquid 16 is moved in the display space S toward the scanning electrode 6 that makes a potential difference from the signal electrodes 4. Consequently, the conductive liquid 16 has been moved toward the non-effective display region P2, as shown in FIG. 4B, and allows the illumination light emitted from the backlight 18 to reach the color filter 11r by shifting the oil 17 toward the reference electrode 5. Thus, the display color on the display surface becomes red display (i.e., the CF color display) due to the color filter 11r. Like Table 1, when the CF color display is performed in all the three adjacent R, G, and B pixels, the white display is performed.

In the selected line, when the H voltage is applied to the signal electrodes 4, a potential difference occurs between the reference electrode 5 and the signal electrodes 4, but not between the signal electrodes 4 and the scanning electrode 6. Therefore, the conductive liquid 16 is moved in the display space S toward the reference electrode 5 that makes a potential difference from the signal electrodes 4. Consequently, the conductive liquid 16 has been moved toward the effective display region P1, as shown in FIG. 4A, and prevents the illumination light emitted from the backlight 18 from reaching the color filter 11r. Thus, the display color on the display surface becomes black display (i.e., the non-CF color display) due to the presence of the conductive liquid 16.

### <Non-Selected Line Operation>

In the non-selected lines, e.g., when the L voltage is applied to the signal electrodes 4, the conductive liquid 16 stands still in the same position, and the current display color is maintained. Since the M voltages are applied to both the reference electrodes 5 and the scanning electrodes 6, the potential difference between the reference electrodes 5 and the signal electrodes 4 is the same as that between the scanning electrodes 6 and the signal electrodes 4. Consequently, the display color is maintained without changing from the black display or the CF color display in the current state.

Similarly, in the non-selected lines, even when the H voltage is applied to the signal electrodes 4, the conductive liquid 16 stands still in the same position, and the current display color is maintained. Since the M voltages are applied to both the reference electrodes 5 and the scanning electrodes 6, the potential difference between the reference electrodes 5 and the signal electrodes 4 is the same as that between the scanning electrodes 6 and the signal electrodes 4.

In the non-selected lines, as shown in Table 2, similarly to Table 1, the conductive liquid 16 is not moved, but stands still and the display color on the display surface is unchanged regardless of whether the H or L voltage is applied to the signal electrodes 4.

On the other hand, in the selected line, the conductive liquid 16 can be moved in accordance with the voltage applied to the signal electrodes 4, as described above, and the display color on the display surface can be changed accordingly.

In the image display apparatus 1 of this embodiment, other than the combinations of the applied voltages shown in Tables 1 and 2, the voltage applied to the signal electrodes 4 not only has two values of the H voltage and the L voltage, but also may be changed between the H voltage and the L voltage in accordance with information to be displayed on the display surface. That is, the image display apparatus 1 can perform the gradation display by controlling the signal voltage Vd. Thus, the display device 10 can achieve excellent display performance.

In the display device 10 of this embodiment having the above configuration, the ribs 14 are provided on the lower substrate (i.e., one of the first and second substrates) 3 so as to partition the inside of the display space S in accordance with each of the pixel regions P. In the display device 10 of this embodiment, the ribs 14 include the first rib members 14a formed parallel to the perpendicular direction perpendicular to the direction of movement of the conductive liquid 16 and the second rib members 14b formed parallel to the parallel direction parallel to the direction of movement of the conductive liquid 16. Moreover, in the display device 10 of this embodiment, the clearances K through which the adjacent pixel regions P can communicate with each other are formed between each of the ends of the first and second rib members 14a, 14b. Therefore, each of the pixel regions P has four clearances K in the four corners. Thus, unlike the conventional example, the conductive liquid 16 can be moved smoothly in the display device 10 of this embodiment, so that the speed of movement of the conductive liquid 16 can be improved.

In the image display apparatus (electric apparatus) 1 of this embodiment, the display device 10 is used in the display portion. Therefore, a high-performance pixel display apparatus (electric apparatus) 1 capable of changing the display color in each of the pixel regions P at a high speed can be easily provided.

In the display device 10 of this embodiment, the signal driver (signal voltage application portion) 7, the reference driver (reference voltage application portion) 8, and the scanning driver (scanning voltage application portion) 9 apply the signal voltage Vd, the reference voltage Vr, and the scanning voltage Vs to the signal electrodes 4, the reference electrodes 5, and the scanning electrodes 6, respectively. Thus, in this embodiment, a matrix-driven display device 10 with excellent display quality can be easily provided, and the display color in each of the pixel regions can be appropriately changed.

### Embodiment 2

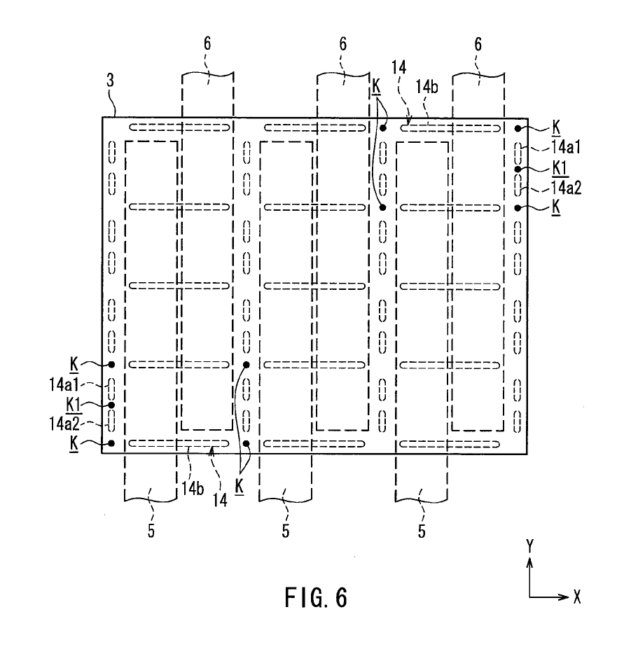

FIG. 6 is an enlarged plan view showing the main configuration of a lower substrate in a display device of Embodiment 2 of the present invention when viewed from a non-display surface side. In FIG. 6, this embodiment mainly differs from Embodiment 1 in that the first rib member is divided into two parts in the perpendicular direction, and a clearance is formed between the two parts. The same components as those of Embodiment 1 are denoted by the same reference numerals, and the explanation will not be repeated.

As shown in FIG. 6, the display device 10 of this embodiment includes a plurality of, e.g., two first rib members 14a1, 14a2. These first rib members 14a1, 14a2 are provided by dividing the first rib member 14a (FIG. 3) of Embodiment 1 into two parts in the perpendicular direction. Moreover, a clearance K1 through which the adjacent pixel regions P can communicate with each other is formed between the first rib members 14a1, 14a2.

The size of the clearance K1 in the Y direction is set in the range of 2% to 20% of the vertical size.

With the above configuration, this embodiment can have effects comparable to those of Embodiment 1. In this embodiment, the clearance K1 is provided between the first rib members 14a1, 14a2 that are separated in the perpendicular direction, in addition to the clearances K. This makes it easier for the conductive liquid 16 to be moved smoothly, and also ensures that the speed of movement of the conductive liquid 16 can be improved.

### Embodiment 3

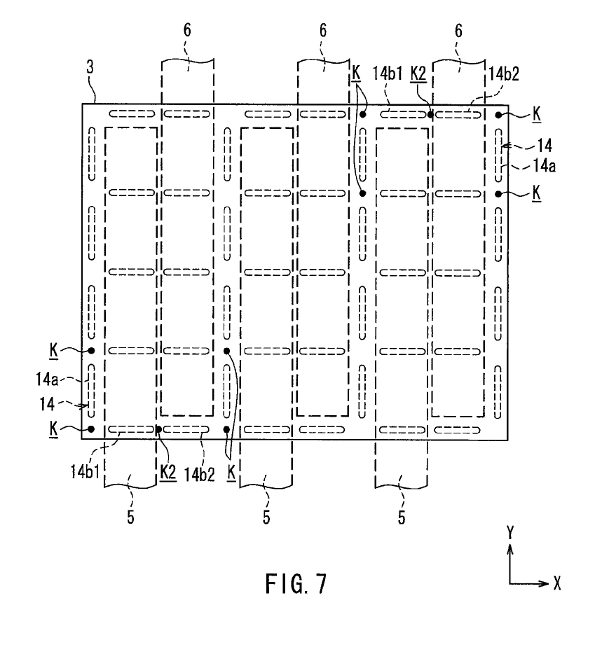

FIG. 7 is an enlarged plan view showing the main configuration of a lower substrate in a display device of Embodiment 3 of the present invention when viewed from a non-display surface side. In FIG. 7, this embodiment mainly differs from Embodiment 1 in that the second rib member is divided into two parts in the parallel direction so that a clearance is formed between the effective display region and the non-effective display region. The same components as those of Embodiment 1 are denoted by the same reference numerals, and the explanation will not be repeated.

As shown in FIG. 7, the display device 10 of this embodiment includes a plurality of, e.g., two second rib members 14b1, 14b2. These second rib members 14b1, 14b2 are provided by dividing the second rib member 14b (FIG. 3) of Embodiment 1 into two parts in the parallel direction. Moreover, a clearance K2 through which the adjacent pixel regions P can communicate with each other is formed between the second rib members 14b1, 14b2 so as to be located between the effective display region P1 and the non-effective display region P2.

The size of the clearance K2 in the X direction is set in the range of 2% to 20% of the lateral size.

With the above configuration, this embodiment can have effects comparable to those of Embodiment 1. In this embodiment, the clearance K2 is provided between the second rib members 14b1, 14b2 that are separated in the parallel direction, in addition to the clearances K. This makes it easier for the conductive liquid 16 to be moved smoothly, and also ensures that the speed of movement of the conductive liquid 16 can be improved. Moreover, since the clearance K2 is formed between the effective display region P1 and the non-effective display region P2, when the conductive liquid 16 is moved toward the effective display region P1 or the non-effective display region P2, the clearance K2 is present in the vicinity of the starting point of the movement of the conductive liquid 16. Therefore, the conductive liquid 16 can be moved more smoothly, and the speed of movement of the conductive liquid 16 can be improved more reliably.

### Embodiment 4

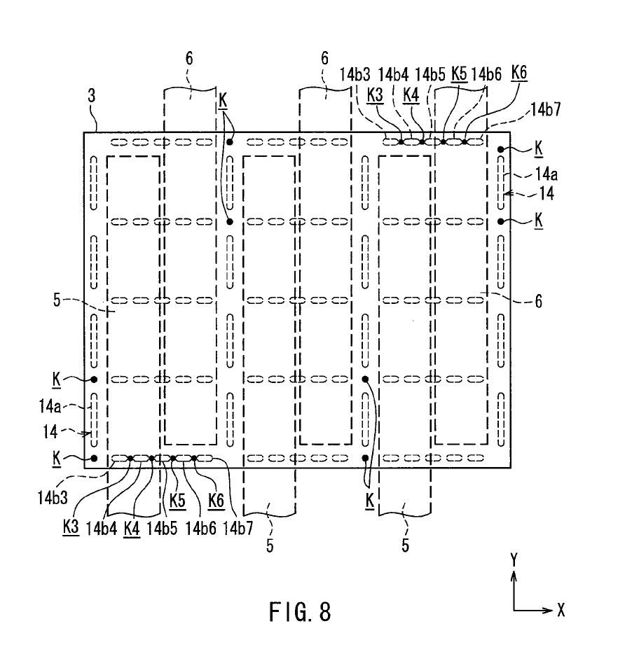

FIG. 8 is an enlarged plan view showing the main configuration of a lower substrate in a display device of Embodiment 4 of the present invention when viewed from a non-display surface side. In FIG. 8, this embodiment mainly differs from Embodiment 1 in that the second rib member is divided into five parts in the parallel direction, and a clearance is formed between each of the five parts. The same components as those of Embodiment 1 are denoted by the same reference numerals, and the explanation will not be repeated.

As shown in FIG. 8, the display device 10 of this embodiment includes a plurality of, e.g., five second rib members 14b3, 14b4, 14b5, 14b6, and 14b7. These second rib members 14b3 to 14b7 are provided by dividing the second rib member 14b (FIG. 3) of Embodiment 1 into five equal parts in the parallel direction. Moreover, a clearance K3 through which the adjacent pixel regions P can communicate with each other is formed between the second rib members 14b3, 14b4. Similarly, a clearance K4 through which the adjacent pixel regions P can communicate with each other is formed between the second rib members 14b4, 14b5. Similarly, a clearance K5 through which the adjacent pixel regions P can communicate with each other is formed between the second rib members 14b5, 14b6. Similarly, a clearance K6 through which the adjacent pixel regions P can communicate with each other is formed between the second rib members 14b6, 14b7.

The clearances K3 to K6 have the same size, and the size of each of the clearances K3 to K6 in the X direction is set in the range of 2% to 8% of the lateral size.

With the above configuration, this embodiment can have effects comparable to those of Embodiment 1. In this embodiment, the clearances K3 to K6 are provided between each of the second rib members 14b3 to 14b7 that are separated in the parallel direction, in addition to the clearances K. This makes it easier for the conductive liquid 16 to be moved smoothly, and also ensures that the speed of movement of the conductive liquid 16 can be improved.

### Embodiment 5

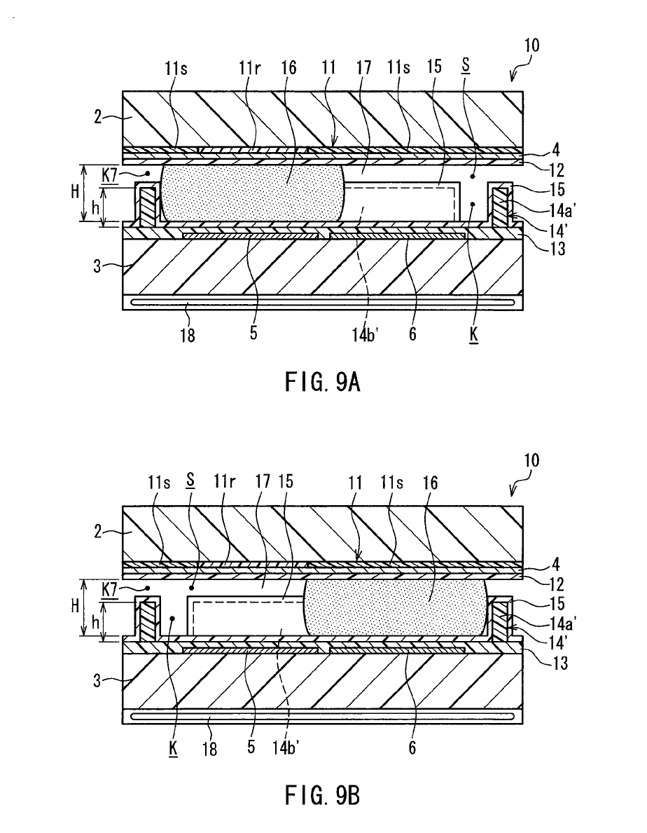

FIGS. 9A and 9B are cross-sectional views showing the main configuration of a display device of Embodiment 5 of the present invention during non-CF color display and CF color display, respectively. In FIGS. 9A and 9B, this embodiment mainly differs from Embodiment 1 in that a clearance is formed between the upper substrate and the first and second rib members. The same components as those of Embodiment 1 are denoted by the same reference numerals, and the explanation will not be repeated.

As shown in FIGS. 9A and 9B, a clearance K7 through which the adjacent pixel regions P can communicate with each other is formed between the upper substrate 2 and ribs 14′ in the display device 10 of this embodiment. Specifically, like Embodiment 1, the ribs 14′ include first rib members 14a′ formed parallel to the perpendicular direction perpendicular to the direction of movement of the conductive liquid 16 and second rib members 14b′ formed parallel to the parallel direction parallel to the direction of movement of the conductive liquid 16.

As shown in FIG. 9, a height h of the first and second rib members 14a′, 14b′ in the direction perpendicular to the upper substrate 2 and the lower substrate 3 (i.e., the longitudinal direction of FIG. 9) is set to be smaller than a gap size H of the display space S in the perpendicular direction. In other words, the height h of the first and second rib members 14a′, 14b′, i.e., the height by which the first and second rib members 14a′, 14b′ protrude from the dielectric layer 13 is set to be smaller than the gap size H of the display space S, i.e., the distance between the hydrophobic film 12 and the hydrophobic film 15. Thus, the speed of movement of the conductive liquid 16 can be improved while preventing the flow of the conductive liquid 16 between the adjacent pixels.

With the above configuration, this embodiment can have effects comparable to those of Embodiment 1. In this embodiment, the clearance K7 is provided between the upper substrate 2 and the first and second rib members 14a′, 14b′, in addition to the clearances K. This makes it easier for the conductive liquid 16 to be moved smoothly, and also ensures that the speed of movement of the conductive liquid 16 can be improved.

It should be noted that the above embodiments are all illustrative and not restrictive. The technological scope of the present invention is defined by the appended claims, and all changes that come within the range of equivalency of the claims are intended to be embraced therein.

For example, in the above description, the present invention is applied to an image display apparatus including a display portion that can display color images. However, the present invention is not limited thereto, as long as it is applied to an electric apparatus with a display portion that displays the information including characters and images. For example, the present invention is suitable for various electric apparatuses with display portions such as a personal digital assistant such as an electronic organizer, a display apparatus for a personal computer or television, and an electronic paper.

In the above description, the electrowetting-type display device is used, in which the conductive liquid is moved in accordance with the application of an electric field to the conductive liquid. However, the display device of the present invention is not limited thereto, as long as it is an electric-field-induced display device that can change the display color on the display surface by moving the conductive liquid in the display space with the use of an external electric field. For example, the present invention can be applied to other types of electric-field-induced display devices such as an electroosmotic type, an electrophoretic type, and a dielectrophoretic type.

As described in each of the above embodiments, the electrowetting-type display device is preferred because the conductive liquid can be moved at a high speed and a low drive voltage. Moreover, since three different electrodes are used to move the conductive liquid slidably, the electrowetting-type display device can achieve both a high switching speed of the display color on the display surface and electric power saving more easily than the display device in which the shape of the conductive liquid is changed. In the electrowetting-type display device, the display color is changed with the movement of the conductive liquid. Therefore, unlike a liquid crystal display apparatus or the like, there is no viewing angle dependence. Moreover, since a switching device does not need to be provided for each pixel, a high-performance matrix-driven display device having a simple structure can be achieved at a low cost. Further, the electrowetting-type display device does not use a birefringent material such as a liquid crystal layer. Therefore, it is possible to easily provide a high brightness display device with excellent utilization efficiency of light from the backlight or ambient light used for information display.

In the above description, the ribs include the first rib members formed in the perpendicular direction perpendicular to the direction of movement of the conductive liquid and the second rib members formed in the parallel direction parallel to the direction of movement of the conductive liquid. Moreover, the clearances are formed between each of the ends of the first and second rib members, between the divided first or second rib members, or between the upper substrate (first substrate) and the first and second rib members. However, the present invention is not limited thereto, as long as clearances are formed with respect to the ribs so that the adjacent pixel regions can communicate with each other. Specifically, in frame-shaped ribs composed of two first rib members and two second rib members, in which the first rib members are connected to the second rib members with their ends being at right angles, a clearance may be formed between the first substrate and the frame-shaped ribs. Moreover, a clearance may be formed by a through hole that passes through a part of the first and/or second rib members so that the adjacent pixel regions can communicate with each other.

In the above description, the ribs are provided on the lower substrate (second substrate). However, the ribs of the present invention are not limited thereto, as long as the ribs are provided on one of the upper substrate (first substrate) and the lower substrate (second substrate) so as to partition the inside of the display space in accordance with each of the pixel regions. That is, the ribs may be provided on the first substrate on the display surface side.

The above description refers to the transmission type display device including a backlight. However, the present invention is not limited thereto, and may be applied to a reflection type display device including a light reflection portion such as a diffuse reflection plate, a semi-transmission type display device including the light reflection portion along with a backlight, or the like.

In the above description, the signal electrodes are provided on the upper substrate (first substrate) and the reference electrodes and the scanning electrodes are provided on the lower substrate (second substrate). However, the present invention is not limited thereto, and may have a configuration in which the signal electrodes are placed in the display space so as to come into contact with the conductive liquid, and the reference electrodes and the scanning electrodes are provided on one of the first substrate and the second substrate so as to be electrically insulated from the conductive liquid and each other. Specifically, e.g., the signal electrodes may be provided on the second substrate or on the ribs, and the reference electrodes and the scanning electrodes may be provided on the first substrate.

In the above description, the reference electrodes and the scanning electrodes are located on the effective display region side and the non-effective display region side, respectively. However, the present invention is not limited thereto, and the reference electrodes and the scanning electrodes may be located on the non-effective display region side and the effective display region side, respectively.

In the above description, the reference electrodes and the scanning electrodes are provided on the surface of the lower substrate (second substrate) that faces the display surface side. However, the present invention is not limited thereto, and can use the reference electrodes and the scanning electrodes that are buried in the second substrate made of an insulating material. In this case, the second substrate also can serve as a dielectric layer, which can eliminate the formation of the dielectric layer. Moreover, the signal electrodes may be directly provided on the first and second substrates serving as dielectric layers, and thus may be placed in the display space.

In the above description, the reference electrodes and the scanning electrodes are made of transparent electrode materials. However, the present invention is not limited thereto, as long as either one of the reference electrodes and the scanning electrodes, which are arranged to face the effective display regions of the pixels, are made of the transparent electrode materials. The other electrodes that do not face the effective display regions can be made of opaque electrode materials such as aluminum, silver, chromium, and other metals.

In the above description, the reference electrodes and the scanning electrodes are in the form of stripes. However, the shapes of the reference electrodes and the scanning electrodes of the present invention are not limited thereto. For example, the reflection type display device may use linear or mesh electrodes that are not likely to cause a light loss, since the utilization efficiency of light used for information display is lower in the reflection type display device than in the transmission type display device.

In the above description, the signal electrodes are linear wiring. However, the signal electrodes of the present invention are not limited thereto, and can be wiring with other shapes such as mesh wiring.

As described in each of the above embodiments, it is preferable that the shape of the signal electrodes is determined using the transmittance of the reference electrodes and the scanning electrodes that are transparent electrodes. This is because even if the signal electrodes are made of an opaque material, shadows of the signal electrodes can be prevented from appearing on the display surface, and thus a decrease in display quality can be suppressed. The use of the linear wiring is more preferred because the decrease in display quality can be reliably suppressed.

In the above description, the conductive liquid is a potassium chloride aqueous solution, and the signal electrodes include at least one of gold, silver, copper, platinum, and palladium. However, the present invention is not limited thereto, as long as a material that is electrochemically inert to the conductive liquid is used for the signal electrodes that are placed in the display space and come into contact with the conductive liquid. Specifically, the conductive liquid can be, e.g., a material including an electrolyte such as a zinc chloride, potassium hydroxide, sodium hydroxide, alkali metal hydroxide, zinc oxide, sodium chloride, lithium salt, phosphoric acid, alkali metal carbonate, or ceramics with oxygen ion conductivity. The solvent can be, e.g., an organic solvent such as alcohol, acetone, formamide, or ethylene glycol other than water. The conductive liquid of the present invention also can be an ionic liquid (room temperature molten salt) including pyridine-, alicyclic amine-, or aliphatic amine-based cations and fluorine anions such as fluoride ions or triflate.

As described in each of the above embodiments, the aqueous solution in which a predetermined electrolyte is dissolved is preferred for the conductive liquid because the display device can have excellent handling properties and also be easily produced.

The signal electrodes of the present invention may be in the passive state including an electrode body composed of a conductive metal such as aluminum, nickel, iron, cobalt, chromium, titanium, tantalum, niobium, or an alloy thereof and an oxide film disposed to cover the surface of the electrode body.

As described in each of the above embodiments, the signal electrodes including at least one of gold, silver, copper, platinum, and palladium are preferred because these metals have a low ionization tendency and make it possible not only to simplify the signal electrodes, but also to reliably prevent an electrochemical reaction between the signal electrodes and the conductive liquid. Thus, the display device can easily prevent a reduction in the reliability and have a long life. Moreover, with the use of the metals having a low ionization tendency, the interfacial tension at the interface between the signal electrodes and the conductive liquid can be relatively small. Therefore, when the conductive liquid is not moved, it can be easily held in a stable state at the fixed position.

In the above description, the nonpolar oil is used. However, the present invention is not limited thereto, as long as an insulating fluid that is not mixed with the conductive liquid is used. For example, air may be used instead of the oil. Moreover, silicone oil or an aliphatic hydrocarbon also can be used as the oil.

As described in each of the above embodiments, the nonpolar oil that is not compatible with the conductive liquid is preferred because the droplets of the conductive liquid move more easily in the nonpolar oil compared to the use of air and the conductive liquid. Consequently, the conductive liquid can be moved at a high speed, and the display color can be switched at a high speed.

In the above description, the black colored conductive liquid and the color filter layer are used to form the pixels of R, G, and B colors on the display surface side. However, the present invention is not limited thereto, as long as a plurality of pixel regions are provided in accordance with a plurality of colors that enable full-color display to be shown on the display surface. Specifically, the conductive liquids with different colors such as RGB, CMY composed of cyan (C), magenta (M), and yellow (Y), or RGBYC also can be used.

In the above description, the color filter layer is formed on the surface of the upper substrate (first substrate) that faces the non-display surface side. However, the present invention is not limited thereto, and the color filter layer may be formed on the surface of the first substrate that faces the display surface side or on the lower substrate (second substrate). Thus, the color filter layer is preferred compared to the use of the conductive liquids with different colors because the display device can be easily produced. Moreover, the color filter layer is also preferred because the effective display region and the non-effective display region can be properly and reliably defined with respect to the display space by the color filter (aperture) and the black matrix (light-shielding layer) included in the color filter layer, respectively.

In addition to the above description, Embodiments 1 to 5 may be appropriately combined.

### INDUSTRIAL APPLICABILITY

The present invention is useful for a display device that can improve the speed of movement of a conductive liquid, and an electric apparatus using the display device.

### DESCRIPTION OF REFERENCE NUMERALS

1 Image display apparatus (electric apparatus)
2 Upper substrate (first substrate)
3 Lower substrate (second substrate)
4 Signal electrode
5 Reference electrode
6 Scanning electrode
7 Signal driver (signal voltage application portion)
8 Reference driver (reference voltage application portion)
9 Scanning driver (scanning voltage application portion)
10 Display device
11 Color filter layer
11r, 11g, 11b Color filter (aperture)
11s Black matrix (light-shielding layer)
13 Dielectric layer
14, 14′ Rib
14a, 14a1, 14a2, 14a′ First rib member
14b, 14b1, 14b2, 14b3, 14b4, 14b5, 14b6, 14b7, 14b′ Second rib member
16 Conductive liquid
17 Oil (insulating fluid)

S Display space

P Pixel region

P1 Effective display region
P2 Non-effective display region
K, K1, K2, K3, K4, K5, K6, K7 Clearance

1. A display device that comprises a first substrate provided on a display surface side, a second substrate provided on a non-display surface side of the first substrate so that a predetermined display space is formed between the first substrate and the second substrate, an effective display region and a non-effective display region that are defined with respect to the display space, and a conductive liquid sealed in the display space so as to be moved toward the effective display region or the non-effective display region, and that is capable of changing a display color on the display surface side by moving the conductive liquid,
wherein the display device comprises:
a plurality of signal electrodes that are placed in the display space so as to come into contact with the conductive liquid, and are also provided along a predetermined arrangement direction;
a plurality of reference electrodes that are provided on one of the first substrate and the second substrate so as to be electrically insulated from the conductive liquid and to be located on one of the effective display region side and the non-effective display region side, and are also arranged so as to intersect with the plurality of the signal electrodes;
a plurality of scanning electrodes that are provided on one of the first substrate and the second substrate so as to be electrically insulated from the conductive liquid and the plurality of the reference electrodes and to be located on the other of the effective display region side and the non-effective display region side, and are also arranged so as to intersect with the plurality of the signals electrodes;
a plurality of pixel regions that are located at each of the intersections of the plurality of the signal electrodes and the plurality of the scanning electrodes; and
ribs that are provided on one of the first substrate and the second substrate so as to partition an inside of the display space in accordance with each of the plurality of the pixel regions, and
wherein the ribs are provided with clearances through which the adjacent pixel regions can communicate with each other.

2. The display device according to claim 1, wherein the ribs include first rib members formed in a perpendicular direction perpendicular to a direction of movement of the conductive liquid and second rib members formed in a parallel direction parallel to the direction of movement of the conductive liquid, and
at least one of the first rib members and the second rib members are provided with the clearances.

3. The display device according to claim 2, wherein each of the first rib members is divided into a plurality of first rib members in the perpendicular direction, and at least one of the clearances is formed between the divided first rib members.

4. The display device according to claim 2, wherein each of the second rib members is divided into a plurality of second rib members in the parallel direction, and at least one of the clearances is formed between the divided second rib members.

5. The display device according to claim 2, wherein each of the second rib members is divided into a plurality of second rib members in the parallel direction so that the clearances are formed at least between the effective display region and the non-effective display region.

6. The display device according to claim 1, wherein the ribs include first rib members formed in a perpendicular direction perpendicular to a direction of movement of the conductive liquid and second rib members formed in a parallel direction parallel to the direction of movement of the conductive liquid, and
the clearances are formed between each of ends of the first rib members and the second rib members.

7. The display device according to claim 1, wherein the ribs are provided on one of the first substrate and the second substrate so that the clearances are formed between the ribs and the other of the first substrate and the second substrate.

8. The display device according to claim 1, wherein the display device comprises:
a signal voltage application portion that is connected to the plurality of the signal electrodes and applies a signal voltage in a predetermined voltage range to each of the signal electrodes in accordance with information to be displayed on the display surface side;
a reference voltage application portion that is connected to the plurality of the reference electrodes and applies one of a selected voltage and a non-selected voltage to each of the reference electrodes, the selected voltage allowing the conductive liquid to move in the display space in accordance with the signal voltage and the non-selected voltage inhibiting a movement of the conductive liquid in the display space; and
a scanning voltage application portion that is connected to the plurality of the scanning electrodes and applies one of a selected voltage and a non-selected voltage to each of the scanning electrodes, the selected voltage allowing the conductive liquid to move in the display space in accordance with the signal voltage and the non-selected voltage inhibiting a movement of the conductive liquid in the display space.

9. The display device according to claim 1, wherein the plurality of the pixel regions are provided in accordance with a plurality of colors that enable full-color display to be shown on the display surface side.

10. The display device according to claim 1, wherein an insulating fluid that is not mixed with the conductive liquid is movably sealed in the display space.

11. The display device according to claim 1, wherein a dielectric layer is formed on the surfaces of the plurality of the reference electrodes and the plurality of the scanning electrodes.

12. The display device according to claim 1, wherein the non-effective display region is defined by a light-shielding layer that is provided on one of the first substrate and the second substrate, and
the effective display region is defined by an aperture formed in the light-shielding layer.

13. An electric apparatus comprising a display portion that displays information including characters and images,
wherein the display portion comprises the display device according to claim 1.
